(19) United States
(12) Patent Application Publication
(10) Pub. No.: US 2026/0140552 A1
(43) Pub. Date: May 21, 2026

(54) COMPUTING DEVICE CASE

(71) Applicant: Microsoft Technology Licensing, LLC, Redmond, WA (US)

(72) Inventors: Sneha Rajeev SONDUR, Seattle, WA (US); Yonatan Moges BEYENE, Bellevue, WA (US); Donghwi KIM, Kirkland, WA (US)

(73) Assignee: Microsoft Technology Licensing, LLC, Redmond, WA (US)

(21) Appl. No.: 18/909,855

(22) Filed: Oct. 8, 2024

(51) Int. Cl. G06F 1/20; G06F 3/0346

(52) U.S. Cl. CPC G06F 1/203; G06F 3/0346

(57) ABSTRACT

A case for a computing device comprises a rotatable platform, a piezoelectric air mover mounted to the rotatable platform, and a sensor. A processor is configured to execute instructions stored in memory to receive data from the sensor and, based at least on the data from the sensor, cause the rotatable platform to rotate the piezoelectric air mover.

### BACKGROUND

Electronic devices can utilize one or more fans and vents to dissipate heat. In some devices and use cases, achieving sufficient heat dissipation can be challenging.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

In some examples, a case for a computing device comprises a rotatable platform and a piezoelectric air mover mounted to the rotatable platform. The case includes a sensor, a processor, and memory storing instructions executable by the processor to receive data from the sensor, and based at least on the data from the sensor, cause the rotatable platform to rotate the piezoelectric air mover.

In some examples, a method is provided for rotating a piezoelectric air mover in a case for a computing device, with the case comprising a sensor and a rotatable platform to which the piezoelectric air mover is mounted. The method includes receiving data from the sensor and, based at least on the data from the sensor, causing the rotatable platform to rotate the piezoelectric air mover.

In some examples, a case for a computing device comprises a plurality of rotatable platforms, and a piezoelectric air mover mounted to each rotatable platform. The case includes a sensor, a processor, and memory storing instructions executable by the processor to receive data from the sensor, and based at least on the data from the sensor, cause at least one of the rotatable platforms to rotate the corresponding piezoelectric air mover.

### BRIEF DESCRIPTION OF THE DRAWINGS

FIG. 1 depicts an example case and computing device according to examples of the present disclosure.

FIG. 2 is a schematic cross-section view of the case and computing device of FIG. 1 according to examples of the present disclosure.

FIG. 3 is a schematic cross-section view of another case and computing device according to examples of the present disclosure.

FIG. 4 is a schematic cross-section view of another case and computing device according to examples of the present disclosure.

FIG. 5 is a schematic top view of the example case and computing device of FIG. 2 in which piezoelectric air movers are directing air through vents according to examples of the present disclosure.

FIG. 6 is a schematic top view of the example case and computing device of FIG. 4 in which the piezoelectric air movers are rotated to direct air through different vents according to examples of the present disclosure.

FIGS. 7A and 7B illustrate an example method of rotating a piezoelectric air mover in a case for a computing device according to examples of the present disclosure.

FIG. 8 is a block diagram of an example computing system according to examples of the present disclosure.

### DETAILED DESCRIPTION

Electronic devices can utilize one or more fans and vents to dissipate internal heat. In some devices and use cases, achieving sufficient heat dissipation can be challenging. For example, some computing devices are utilized in very bright environments, such as in direct sunlight. To provide sufficient readability, the displays in these devices can generate brightness ranging from 600 nits up to 2000 nits and higher. In these devices, dissipating heat generated by a Touch Display Module (TDM), CPU, GPU, and/or NPU, all enclosed within the same device chassis, can prove challenging. Such challenges are magnified when these devices are used in high ambient temperature environments. Additionally, exhausting hot air toward the body of a user holding and using the device in a hot environment can create an uncomfortable user experience.

Additionally and in some use cases, an exhaust exit of a device can become partially or fully obstructed, thereby inhibiting airflow and reducing the air circulation and flow rate through the device. This correspondingly causes increasing temperatures in the device that can trigger corrective actions, such as throttling power and performance of the device. Further, some devices utilize a thin form factor that makes the use of larger air movers impractical or impossible.

Accordingly, and to address one or more of these shortcomings, the present disclosure describes cases for a computing devices and related methods that use data from a sensor to cause one or more rotatable platforms in the case to rotate one or more corresponding piezoelectric air movers and direct exits of the air movers towards different vents in the case. As will be described in more detail below, cases of the present disclosure comprise a rotatable platform and a piezoelectric air mover mounted to the rotatable platform. The case includes a sensor, a processor, and memory storing instructions executable by the processor to receive data from the sensor, and based at least on the data from the sensor, cause the rotatable platform to rotate the piezoelectric air mover. With these configurations, and in one potential advantage of the present disclosure described further below, the piezoelectric air mover can be rotated from a first position that directs an exit of the air mover towards a first vent in the case to a second position that directs the exit towards a second vent in the case.

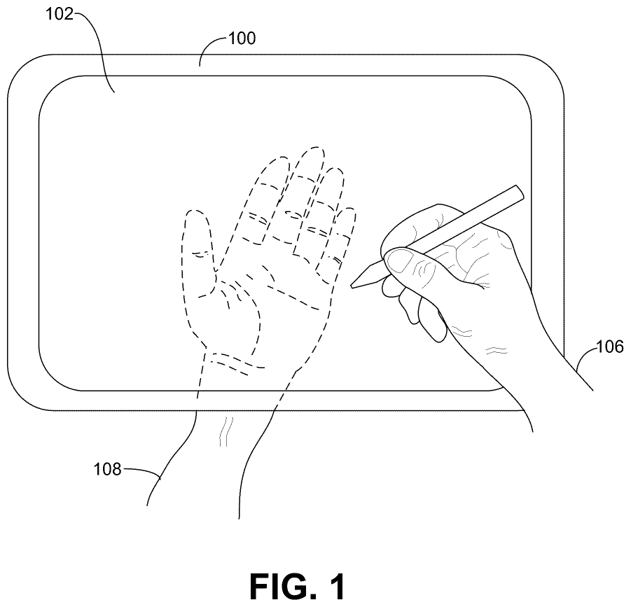

FIG. 1 depicts an example case 100 partially enclosing a computing device 102 according to aspects of the present disclosure. In the present example computing device 102 comprises a tablet computing device configured to be held in one or both hands 106, 108 of a user. In other examples, cases of the present disclosure can be utilized with a wide variety of other types and form factors of electronic devices, including but not limited to laptop devices, hybrid or 2-in-1 devices with detachable keyboards, gaming devices, desktop devices, wearable electronic device, and displays. For example, portable computing devices having thin form factors can benefit from utilizing small, thin, and efficient thermal management devices such as embodiments of cases described herein.

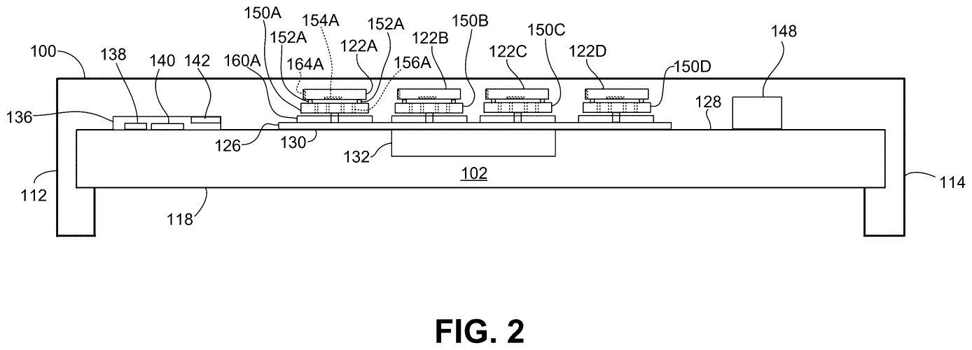

In one example and with reference now to FIG. 2, case 100 comprises opposing ends 112, 114 that extend beyond ends of the chassis 118 of computing device 102. As described in more detail below, in this example case 100 includes four piezoelectric air movers 122A, 122B, 122C, and 122D operable to intake air from the interior of case 100 and move the air to be discharged from the case. In some examples, piezoelectric air movers 122A, 122B, 122C, and 122D comprise one or more vibrating piezoelectric membranes. In these examples the membranes generate significant suction pressure that pulls air into the intake(s) ports of the air mover from vents in the case 100. In one potential advantage of this disclosure, because of the significant suction pressure generated by piezoelectric air movers 122A, 122B, 122C, and 122D, these air movers can be positioned in a wide variety of locations in the case 100, and in some examples can be located a significant distance from vents in the case. In this manner, packaging space within the case 100 can be more efficiently utilized, as opposed to other traditional device fans that are limited to locations near an intake opening. Additionally, while the present examples utilize four piezoelectric air movers, in other examples one, two, five, or any suitable number of piezoelectric air movers can be utilized with cases of the present disclosure.

In this example, case 100 includes a heat spreader substrate 126 affixed to an internal wall 128 of the case that contacts a rear wall 130 of the chassis 118 of computing device 102. In some examples, the heat spreader substrate 126 comprises an elastic adhesive material that is highly thermally conductive to facilitate heat transfer from the computing device 102 to the case 100. In other examples, the heat spreader substrate 126 is fabricated from a thermally conductive material, such as copper or aluminum.

In the present example, the heat spreader substrate 126 is positioned adjacent to a system on a chip (SOC) 132 of the computing device 102. Advantageously, this configuration facilitates heat transfer from the SOC to the case 100.

Case 100 also includes a printed circuit board (PCB) 136 comprising a processor 138 and memory 140. As described further below, case 100 further includes a sensor 142 configured to output signals that are used to rotate one or more of the piezoelectric air movers 122A, 122B, 122C, and 122D to change the direction of air discharge from the case. In the present example, case 100 also includes a dedicated battery 148 to provide power to the components of PCB 136 and other components of the case described further below.

A description of one piezoelectric air mover 122A and related components will now be provided. The following description applies equally to the other piezoelectric air movers 122B, 122C, and 122D and their related components. In this example, and in one potential advantage of the present disclosure, piezoelectric air mover 122A is mounted to a rotatable platform 150A. In this manner and in one potential advantage of the present disclosure described further below, piezoelectric air mover 122A can be selectively rotated from a first position that directs an exit of the air mover towards a first vent in the case to a second position that directs the exit towards a second vent in the case.

In the example of FIG. 2, piezoelectric air mover 122A comprises an inlet 154A that faces downwardly towards the rotatable platform 150A. Additionally, in this example piezoelectric air mover 122A is mounted to the rotatable platform 150A via two stanchions 152A that create a gap between the air mover and the rotatable platform. In one potential advantage of this configuration, by maintaining a gap between the piezoelectric air mover 122A and the rotatable platform 150A, space is provide for inlet 154A to freely ingest heated air flowing between the air mover and the platform.

Additionally and in another potential advantage of this example, rotatable platform 150A comprises a plurality of perforations 156A that allow airflow from adjacent the heat spreader substrate 126 through the platform and into the inlet 154A. In this manner, this configuration can facilitate greater intake of heated air from locations beneath the rotatable platform 150A.

In the present example, and in another potential advantage of the present disclosure, the rotatable platform 150A is fabricated from a thermally conductive material, such as copper or aluminum, to further facilitate heat transfer from the computing device 102 to the case 100. In the present example and as described further below, rotatable platform 150A is mounted to a servo motor 160A that is selectively operated to rotate the platform and change the angular position of the exit 164A of the piezoelectric air mover 122A. In other examples, a variety of other mechanisms and/or motors can be utilized to rotate each rotatable platform 150A, 150B, 150C, and 150D, including but not limited to hinge mechanisms and belt drive mechanisms.

In other examples, cases of the present disclosure utilize piezoelectric air movers comprising an inlet that faces a direction other than towards the rotatable platform. For example, in some configurations the piezoelectric air movers comprise an inlet that faces away from the rotatable platform. In other configurations the piezoelectric air movers comprise an inlet on one end of the air mover, such as an end opposite to the exit of the air mover. Further and as described below, in some of these examples a non-inlet side of the piezoelectric air mover is affixed to the rotatable platform.

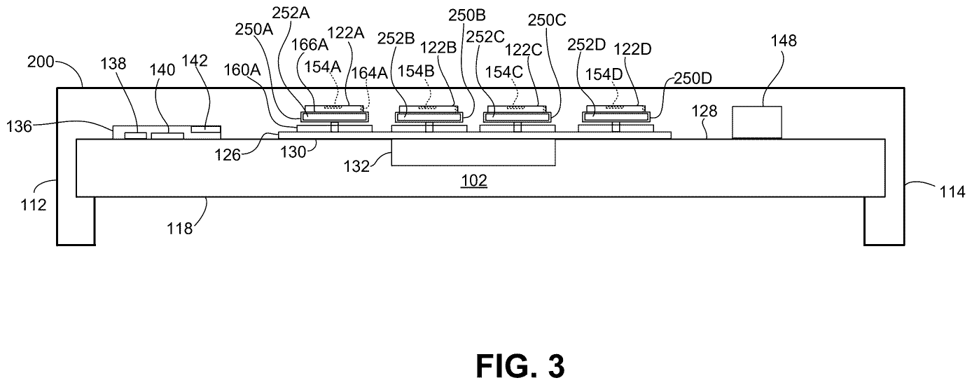

With reference now to FIG. 3, one example case 200 for a computing device 118 in which the piezoelectric air movers comprise an inlet that faces away from the corresponding rotatable platform will now be described. In this example, case 200 includes some of the same components as described above for case 100, and these components are identified by the same reference numerals. A description of one piezoelectric air mover 122A and related components in this configuration will now be provided. The following description applies equally to the other piezoelectric air movers 122B, 122C, and 122D and their related components.

In this example, piezoelectric air mover 122A is oriented to position its inlet 154A facing away from the corresponding rotatable platform 250A. In one potential advantage of this configuration, by positioning the inlet 154A to face away from the rotatable platform 250A, additional space above the inlet can be utilized to increase the volume of air ingested by the inlet. Additionally and in another potential advantage of this configuration, a non-inlet side of the piezoelectric air mover can be affixed directly to the rotatable platform. In the present example, non-inlet side 166A of piezoelectric air mover 122A is affixed to rotatable platform 250A. In one potential advantage of this configuration, heat transfer from the rotatable platform 250A to the piezoelectric air mover 122A and the air internal to the air mover can be increased via such direct contact.

Additionally and in some configurations, the rotatable platforms coupled to the piezoelectric air movers can comprise active heat-transfer devices, including but not limited to various configurations of heat pipes. For example, in the configuration of FIG. 3 each of the rotatable platforms 250A, 250B, 250C, and 250D comprises a respective vapor chamber 252A, 252B, 252C, and 252D. Advantageously, in these examples the vapor chambers actively absorb and dissipate heat from the heat spreader substrate 126 and corresponding motors to provide greater two-dimensional heat flow and transfer to the adjacent piezoelectric air movers 122A, 122B, 122C, and 122D.

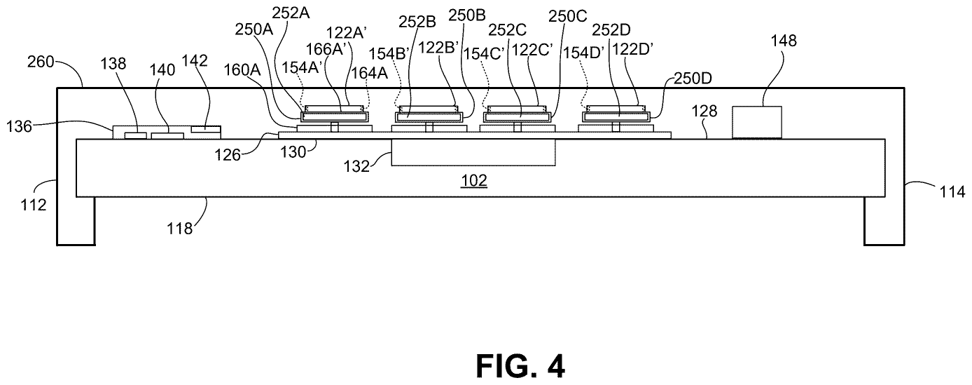

With reference now to FIG. 4, one example case 260 for a computing device 118 in which the piezoelectric air movers comprise an inlet on one end of the air mover will now be described. In this example, case 260 includes some of the same components as described above for cases 100 and 200, and these components are identified by the same reference numerals. A description of one piezoelectric air mover 122A′ and related components in this configuration will now be provided. The following description applies equally to the other piezoelectric air movers 122B′, 122C′, and 122D′ and their related components.

In this example, piezoelectric air mover 122A′ is oriented to position its inlet 154A′ at one end of the air mover between a non-inlet side 166A′ and an opposing upper side. In one potential advantage of this configuration, by positioning the inlet 154A′ on an end of the air mover, space above the upper side of the air mover can be minimized to potentially reduce the thickness of the case 260. Additionally, and similar to the configuration of case 200 described above, non-inlet side 166A′ of the piezoelectric air mover 122A′ can be affixed directly to the rotatable platform. In one potential advantage of this configuration, heat transfer from the rotatable platform 250A to the piezoelectric air mover 122A′ and the air internal to the air mover can be increased via such direct contact.

As noted above, case 100 includes a sensor 142 configured to output signals that are used to rotate one or more of the piezoelectric air movers to change a direction of air discharge from the case. In different examples sensor 142 can comprise an accelerometer, gyroscope, magnetometer, inertial measurement unit (IMU), pressure sensor, and/or touch sensor. In some examples data from sensor 142 is utilized to determine an orientation of the case 100 and computing device 102, including an orientation relative to a body part of a user holding the case. As described in more detail below, based at least on the data from sensor 142, the rotatable platform rotates at least one piezoelectric air mover from a first position to a second position that directs the exit of the air mover towards a different vent in the case.

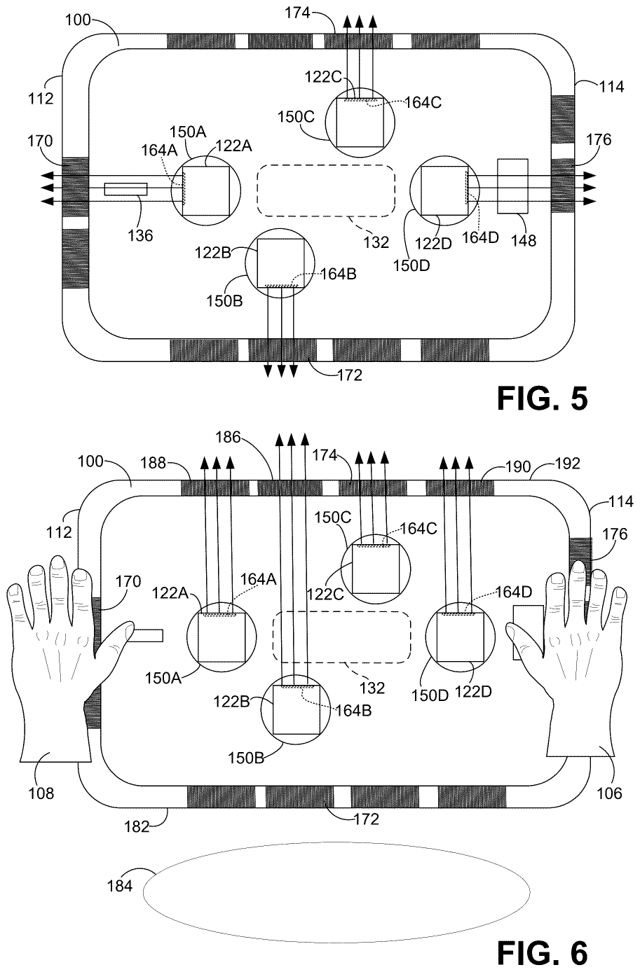

In one example and with reference now to FIG. 5, sensor 142 on PCB 136 is an IMU that measures and reports the orientation of the case 100 to processor 138. In FIG. 5 the case 100 and partially-enclosed computing device are lying flat on a horizontal surface, such as a chair or desk. In this example, using data from the IMU the processor determines that the case 100 and computing device 102 have not moved within a threshold amount of time, such as 10 seconds, and are resting on a horizontal surface. Accordingly, the processor controls each of the rotatable platforms 150A, 150B, 150C, and 150D to rotate its corresponding piezoelectric air mover 122A, 122B, 122C, or 122D to direct its exit 164A, 164B, 164C, and 164D toward the vent nearest to the particular air mover. In this example, rotatable platform 150A rotates its corresponding piezoelectric air mover 122A into a first position that directs its exit 164A toward vent 170 in case 100. Similarly, rotatable platforms 150B, 150C, and 150D rotate their corresponding piezoelectric air movers 122B, 122C, and 122D into positions that directs their exits 164B, 164C, and 164D toward vents 172, 174, and 176, respectively, in case 100.

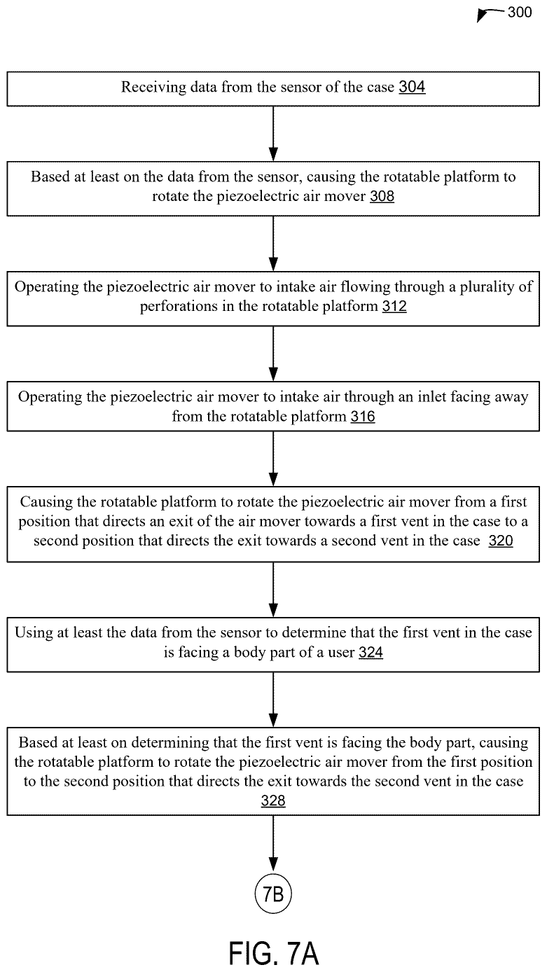

With reference now to FIG. 6, a user has picked up the case 100 and partially enclosed computing device 102 with both hands 106, 108 and is holding the case and device in a landscape orientation with a first side 182 of the case at least partially facing the torso 184 of the user. In one example, using at least data from the IMU the processor executes instructions to determine that the first vent 172 in the case 100 is now facing the user's torso. Based at least on determining that the first vent 172 is facing the user's torso, the processor causes the rotatable platform 150B to rotate the piezoelectric air mover 122B approximately 180 degrees from the first position shown in FIG. 5 (in which heated air was discharged through first vent 172) to the second position shown in FIG. 6 that directs the exit 164B of this air mover towards a second vent 186 on the opposite side of the case 100. Advantageously, in this manner the case 100 dynamically adjusts the direction of air flow from the device to avoid directing heated air toward the body of the user, which could cause undesirable additional heating of the user's body.

Additionally, in this orientation the user's right hand 106 is partially blocking vent 178 on a first end 114 of the case 100, and the user's left hand 108 is partially blocking vent 170 on the opposite second end 112 of the case 100. As shown in FIG. 5, in this example piezoelectric air movers 122A and 122D are positioned to direct their respective exits 164A and 164D toward vents 170 and 176, respectively, which are located laterally from these air movers. Accordingly and in this example, using at least data from the IMU the processor executes instructions to determine that the user's right hand 106 is at least partially blocking vent 176 and the user's left hand 108 is at least partially blocking vent 170.

With reference now to FIG. 6, based at least on determining that the user's right hand 106 is at least partially blocking vent 176 and the user's left hand 108 is at least partially blocking vent 170, the processor causes the rotatable platform 150A to rotate the piezoelectric air movers 122A and 122D approximately 90 degrees from their positions shown in FIG. 5 to the adjusted positions shown in FIG. 6 that direct the exits 164A and 164D of these air movers towards a vents 188 and 190, respectively, on an opposite side 192 of the case 100. Advantageously and in this example, this configuration dynamically adjusts the direction of air flow away from at least partially obstructed case vents to different vents through which air discharged from the piezoelectric air movers 122A and 122D can more freely travel.

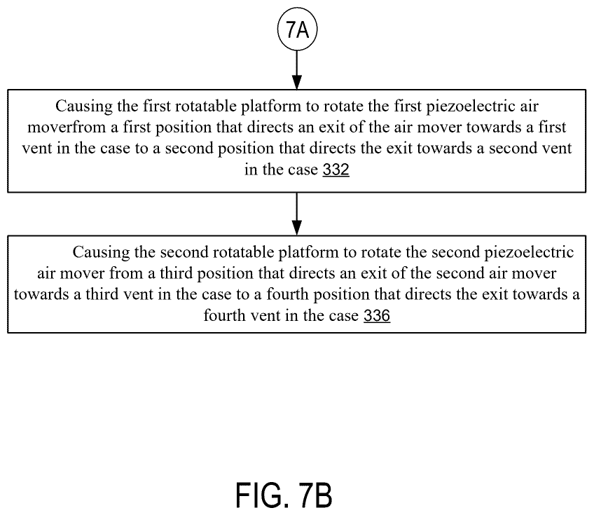

FIGS. 7A and 7B illustrate an example method 300 for rotating a piezoelectric air mover in a case for a computing device, with the piezoelectric air mover mounted to a rotatable platform and the case including a sensor. Method 300 may be implemented using the example configurations of cases 100 and 200 as described above, and using other configurations as contemplated by the present disclosure. The following description of method 300 is provided with reference to the components described herein and shown in FIGS. 1-6 and 8.

It will be appreciated that the following description of method 300 is provided by way of example and is not meant to be limiting. Therefore, it is to be understood that method 300 may include additional and/or alternative steps relative to those illustrated in FIGS. 7A and 7B. Further, it is to be understood that the steps of method 300 may be performed in any suitable order. Further still, it is to be understood that one or more steps may be omitted from method 300 without departing from the scope of this disclosure. It will also be appreciated that method 300 also may be performed in other contexts using other suitable components.

At 304, method 300 includes receiving data from the sensor. At 308 method 300 includes, based at least on the data from the sensor, causing the rotatable platform to rotate the piezoelectric air mover. At 312 method 300 includes operating the piezoelectric air mover to intake air flowing through a plurality of perforations in the rotatable platform. At 316 method 300 includes operating the piezoelectric air mover to intake air through an inlet of the air mover facing away from the rotatable platform. At 320 method 300 includes causing the rotatable platform to rotate the piezoelectric air mover from a first position that directs an exit of the air mover towards a first vent in the case to a second position that directs the exit towards a second vent in the case.

At 324 method 300 includes, using at least the data from the sensor to determine that the first vent in the case is facing a body part of a user. At 328 method 300 includes, based at least on determining that the first vent is facing the body part, causing the rotatable platform to rotate the piezoelectric air mover from the first position to the second position that directs the exit towards the second vent in the case. With reference now to FIG. 7B, at 332 method 300 includes causing the first rotatable platform to rotate the first piezoelectric air mover from a first position that directs an exit of the air mover towards a first vent in the case to a second position that directs the exit towards a second vent in the case. At 336 method 300 includes causing the second rotatable platform to rotate the second piezoelectric air mover from a third position that directs an exit of the second air mover towards a third vent in the case to a fourth position that directs the exit towards a fourth vent in the case.

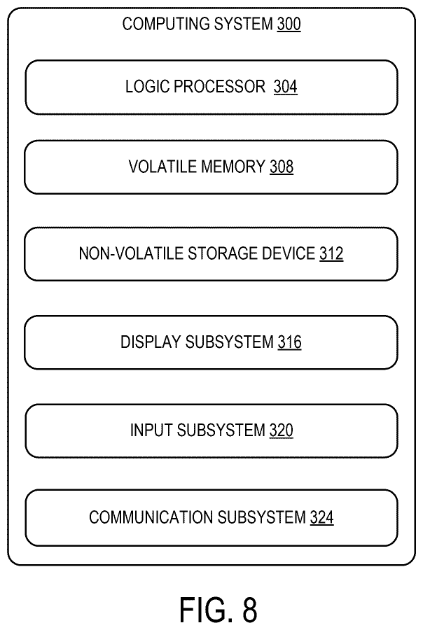

FIG. 8 schematically shows a non-limiting embodiment of a computing system 300 shown in simplified form. Computing system 300 may take the form of one or more electronic devices, including but not limited to laptop computers, hybrid or 2-in-1 computers with detachable keyboards, gaming devices or consoles, desktop computers, wearable electronic devices, mobile communication devices (e.g., smart phones), displays, televisions, and household appliances. In the above examples, PCB 136 of cases 100 and 200 and computing device 102 may comprise computing system 300 or one or more aspects of computing system 300.

Computing system 300 includes a logic processor 304, volatile memory 308, and a non-volatile storage device 312. Computing system 300 may optionally include a display subsystem 316, input subsystem 320, communication subsystem 324, and/or other components not shown in FIG. 8.

Logic processor 304 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 304 may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 304 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 312 includes one or more physical devices configured to hold instructions executable by the logic processors to implement the methods and processes described herein. When such methods and processes are implemented, the state of non-volatile storage device 312 may be transformed—e.g., to hold different data.

Non-volatile storage device 312 may include physical devices that are removable and/or built-in. Non-volatile storage device 312 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 312 may include nonvolatile, dynamic, static, read/write, read-only, sequential-access, location-addressable, file-addressable, and/or content-addressable devices. It will be appreciated that non-volatile storage device 312 is configured to hold instructions even when power is cut to the non-volatile storage device 312.

Volatile memory 308 may include physical devices that include random access memory. Volatile memory 308 is typically utilized by logic processor 304 to temporarily store information during processing of software instructions. It will be appreciated that volatile memory 308 typically does not continue to store instructions when power is cut to volatile memory 308.

Aspects of logic processor 304, volatile memory 308, and non-volatile storage device 312 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

When included, display subsystem 316 may be used to present a visual representation of data held by non-volatile storage device 312. As the herein described methods and processes change the data held by the non-volatile storage device, and thus transform the state of the non-volatile storage device, the state of display subsystem 316 may likewise be transformed to visually represent changes in the underlying data. Display subsystem 316 may include one or more display devices utilizing virtually any type of technology. Such display devices may be combined with logic processor 304, volatile memory 308, and/or non-volatile storage device 312 in a shared enclosure, or such display devices may be peripheral display devices.

When included, input subsystem 320 may comprise or interface with one or more user-input devices such as a stylus, touchpad, keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 324 may be configured to communicatively couple various computing devices described herein with each other, and with other devices. Communication subsystem 324 may include wired and/or wireless communication devices compatible with one or more different communication protocols. As non-limiting examples, the communication subsystem may be configured for communication via a wireless telephone network, or a wired or wireless local-or wide-area network, such as a HDMI over Wi-Fi connection. In some embodiments, the communication subsystem may allow computing system 300 to send and/or receive messages to and/or from other devices via a network such as the Internet.

The following paragraphs provide additional support for the claims of the subject application. One aspect provides a case for a computing device, the case comprising: a rotatable platform; a piezoelectric air mover mounted to the rotatable platform; a sensor; a processor; and memory storing instructions executable by the processor to: receive data from the sensor; and based at least on the data from the sensor, cause the rotatable platform to rotate the piezoelectric air mover. The case may additionally or alternatively include, wherein the rotatable platform comprises a plurality of perforations to allow airflow through the platform. The case may additionally or alternatively include, wherein the piezoelectric air mover comprises an inlet facing the rotatable platform. The case may additionally or alternatively include, wherein the piezoelectric air mover comprises an inlet facing away from the rotatable platform. The case may additionally or alternatively include, wherein the piezoelectric air mover comprises an inlet on an end of the piezoelectric air mover. The case may additionally or alternatively include, wherein the piezoelectric air mover comprises a non-inlet side affixed to the rotatable platform. The case may additionally or alternatively include, wherein the rotatable platform is fabricated from a thermally conductive material. The case may additionally or alternatively include, wherein the rotatable platform comprises a vapor chamber. The case may additionally or alternatively include, wherein the instructions are executable to cause the rotatable platform to rotate the piezoelectric air mover from a first position that directs an exit of the air mover towards a first vent in the case to a second position that directs the exit towards a second vent in the case. The case may additionally or alternatively include, wherein the instructions are executable to: use at least the data from the sensor to determine that the first vent in the case is facing a body part of a user; and based at least on determining that the first vent is facing the body part, cause the rotatable platform to rotate the piezoelectric air mover from the first position to the second position that directs the exit towards the second vent in the case. The case may additionally or alternatively include, wherein the rotatable platform is a first rotatable platform and the piezoelectric air mover is a first piezoelectric air mover, the case comprising a second rotatable platform and a second piezoelectric air mover mounted to the second rotatable platform, wherein the instructions are executable to, based at least on the data from the sensor: cause the first rotatable platform to rotate the first piezoelectric air mover from a first position that directs an exit of the air mover towards a first vent in the case to a second position that directs the exit towards a second vent in the case; and cause the second rotatable platform to rotate the second piezoelectric air mover from a third position that directs an exit of the second air mover towards a third vent in the case to a fourth position that directs the exit towards a fourth vent in the case.

Another aspect provides, in a case for a computing device, the case comprising a rotatable platform, a piezoelectric air mover mounted to the rotatable platform, and a sensor, a method for rotating the piezoelectric air mover, the method comprising: receiving data from the sensor; and based at least on the data from the sensor, causing the rotatable platform to rotate the piezoelectric air mover. The method may additionally or alternatively include operating the piezoelectric air mover to intake air flowing through a plurality of perforations in the rotatable platform. The method may additionally or alternatively include, causing the rotatable platform to rotate the piezoelectric air mover from a first position that directs an exit of the air mover towards a first vent in the case to a second position that directs the exit towards a second vent in the case. The method may additionally or alternatively include, using at least the data from the sensor to determine that the first vent in the case is facing a body part of a user; and based at least on determining that the first vent is facing the body part, causing the rotatable platform to rotate the piezoelectric air mover from the first position to the second position that directs the exit towards the second vent in the case. The method may additionally or alternatively include, wherein the rotatable platform is a first rotatable platform and the piezoelectric air mover is a first piezoelectric air mover, and the case comprises a second rotatable platform and a second piezoelectric air mover mounted to the second rotatable platform, the method further comprising, based at least on the data from the sensor: causing the first rotatable platform to rotate the first piezoelectric air mover from a first position that directs an exit of the air mover towards a first vent in the case to a second position that directs the exit towards a second vent in the case; and causing the second rotatable platform to rotate the second piezoelectric air mover from a third position that directs an exit of the second air mover towards a third vent in the case to a fourth position that directs the exit towards a fourth vent in the case.

Another aspect provides a case for a computing device, the case comprising: a plurality of rotatable platforms; a piezoelectric air mover mounted to each rotatable platform of the plurality of rotatable platforms; a sensor; a processor; and memory storing instructions executable by the processor to: receive data from the sensor; and based at least on the data from the sensor, cause at least one of the rotatable platforms to rotate the corresponding piezoelectric air mover. The case may additionally or alternatively include, wherein each rotatable platform of the plurality of rotatable platform comprises a plurality of perforations to allow airflow through the platform. The case may additionally or alternatively include, wherein each of the piezoelectric air movers comprises an inlet facing the corresponding rotatable platform. The case may additionally or alternatively include, wherein the instructions are executable to cause at least one of the rotatable platforms to rotate the corresponding piezoelectric air mover from a first position that directs an exit of the air mover towards a first vent in the case to a second position that directs the exit towards a second vent in the case.

It will be understood that the configurations and/or approaches described herein are exemplary in nature, and that these specific embodiments or examples are not to be considered in a limiting sense, because numerous variations are possible.

The subject matter of the present disclosure includes all novel and non-obvious combinations and sub-combinations of the various processes, systems and configurations, and other features, functions, acts, and/or properties disclosed herein, as well as any and all equivalents thereof.

The claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure. As used herein, the phrase “and/or” means any or all of multiple stated possibilities.

1. A case for a computing device, the case comprising:
a rotatable platform;
a piezoelectric air mover mounted to the rotatable platform;
a sensor;
a processor; and
memory storing instructions executable by the processor to:
receive data from the sensor; and
based at least on the data from the sensor, cause the rotatable platform to rotate the piezoelectric air mover.

2. The case of claim 1, wherein the rotatable platform comprises a plurality of perforations to allow airflow through the platform.

3. The case of claim 1, wherein the piezoelectric air mover comprises an inlet facing the rotatable platform.

4. The case of claim 1, wherein the piezoelectric air mover comprises an inlet facing away from the rotatable platform.

5. The case of claim 1, wherein the piezoelectric air mover comprises an inlet on an end of the piezoelectric air mover.

6. The case of claim 1, wherein the piezoelectric air mover comprises a non-inlet side affixed to the rotatable platform.

7. The case of claim 1, wherein the rotatable platform is fabricated from a thermally conductive material.

8. The case of claim 1, wherein the rotatable platform comprises a vapor chamber.

9. The case of claim 1, wherein the instructions are executable to cause the rotatable platform to rotate the piezoelectric air mover from a first position that directs an exit of the air mover towards a first vent in the case to a second position that directs the exit towards a second vent in the case.

10. The case of claim 9, wherein the instructions are executable to:
use at least the data from the sensor to determine that the first vent in the case is facing a body part of a user; and
based at least on determining that the first vent is facing the body part, cause the rotatable platform to rotate the piezoelectric air mover from the first position to the second position that directs the exit towards the second vent in the case.

11. The case of claim 1, wherein the rotatable platform is a first rotatable platform and the piezoelectric air mover is a first piezoelectric air mover, the case comprising a second rotatable platform and a second piezoelectric air mover mounted to the second rotatable platform, wherein the instructions are executable to, based at least on the data from the sensor:
cause the first rotatable platform to rotate the first piezoelectric air mover from a first position that directs an exit of the air mover towards a first vent in the case to a second position that directs the exit towards a second vent in the case; and
cause the second rotatable platform to rotate the second piezoelectric air mover from a third position that directs an exit of the second air mover towards a third vent in the case to a fourth position that directs the exit towards a fourth vent in the case.

12. In a case for a computing device, the case comprising a rotatable platform, a piezoelectric air mover mounted to the rotatable platform, and a sensor, a method for rotating the piezoelectric air mover, the method comprising:
receiving data from the sensor; and
based at least on the data from the sensor, causing the rotatable platform to rotate the piezoelectric air mover.

13. The method of claim 12, further comprising operating the piezoelectric air mover to intake air flowing through a plurality of perforations in the rotatable platform.

14. The method of claim 12, further comprising causing the rotatable platform to rotate the piezoelectric air mover from a first position that directs an exit of the air mover towards a first vent in the case to a second position that directs the exit towards a second vent in the case.

15. The method of claim 14, further comprising:
using at least the data from the sensor to determine that the first vent in the case is facing a body part of a user; and
based at least on determining that the first vent is facing the body part, causing the rotatable platform to rotate the piezoelectric air mover from the first position to the second position that directs the exit towards the second vent in the case.

16. The method of claim 12, wherein the rotatable platform is a first rotatable platform and the piezoelectric air mover is a first piezoelectric air mover, and the case comprises a second rotatable platform and a second piezoelectric air mover mounted to the second rotatable platform, the method further comprising, based at least on the data from the sensor:
causing the first rotatable platform to rotate the first piezoelectric air mover from a first position that directs an exit of the air mover towards a first vent in the case to a second position that directs the exit towards a second vent in the case; and
causing the second rotatable platform to rotate the second piezoelectric air mover from a third position that directs an exit of the second air mover towards a third vent in the case to a fourth position that directs the exit towards a fourth vent in the case.

17. A case for a computing device, the case comprising:
a plurality of rotatable platforms;
a piezoelectric air mover mounted to each rotatable platform of the plurality of rotatable platforms;
a sensor;
a processor; and
memory storing instructions executable by the processor to:
receive data from the sensor; and
based at least on the data from the sensor, cause at least one of the rotatable platforms to rotate the corresponding piezoelectric air mover.

18. The case of claim 17, wherein each rotatable platform of the plurality of rotatable platform comprises a plurality of perforations to allow airflow through the platform.

19. The case of claim 17, wherein each of the piezoelectric air movers comprises an inlet facing the corresponding rotatable platform.

20. The case of claim 17, wherein the instructions are executable to cause at least one of the rotatable platforms to rotate the corresponding piezoelectric air mover from a first position that directs an exit of the air mover towards a first vent in the case to a second position that directs the exit towards a second vent in the case.
